(19) United States
(12) Patent Application Publication
(10) Pub. No.: US 2008/0070562 A1
(43) Pub. Date: Mar. 20, 2008

(54) APPARATUS AND METHOD FOR OPERATING RADIO ACCESS NETWORK IN BROADBAND MOBILE COMMUNICATION SYSTEM

(75) Inventors: Sung- Hyun CHO, Suwon-si (KR); Cheol-Woo You, Seoul (KR); Jung-Hoon Cheon, Suwon-si (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/855,366

(22) Filed: Sep. 14, 2007

(30) Foreign Application Priority Data
Sep. 14, 2006 (KR) 2006-0089246

(51) Int. Cl. H04Q 7/20

(52) U.S. Cl. 455/422.1

(57) ABSTRACT

An apparatus and method for operating a radio access network in a broadband mobile communication system are provided. A 1-tier node includes a first communicator for exchanging a plurality of pieces of control information for establishing a call of a Mobile Station (MS) with a higher-tier node, and a controller for allowing data of the MS to be transmitted and received through a radio access network having a 1-tier structure according to call establishment information received from the higher-tier node.

### PRIORITY

This application claims the benefit under 35 U.S.C. §119(a) of Korean patent application filed in the Korean Intellectual Property Office on Sep. 14, 2006 and assigned Serial No. 2006-89246, the entire disclosure of which is hereby incorporated by reference.

### BACKGROUND OF THE INVENTION

1. Field of the Invention

The present invention relates to a broadband mobile communication system. More particularly, the present invention relates to an apparatus and method for operating a radio access network having a complex structure in a broadband mobile communication system.

2. Description of the Related Art

In a mobile communication system, a Mobile Station (MS) accesses a back-bone network through a wireless channel. The back-bone network is a communication network which takes an important role in the provision of services such as the Internet, a Public Switched Telephone Network (PSTN), and so on. The mobile communication system also includes a radio access network. The radio access network controls access of the MS and communication of data traffic between the MS and the back-bone network. In general, the radio access network includes a plurality of nodes having a tier structure.

A conventional radio access network has a 3-tier structure (e.g., Node B, Radio Network Controller (RNC), and Gateway GPRS Support Node (GGSN)). Herein, GPRS is a General Packet Radio Service. Thus, the MS can access the Internet or the PSTN through the three nodes. However, a radio access network having a 2-tier structure (e.g., Enhanced Node B (ENB) and Access Gateway) is highly likely to be accepted as a standard of a 3rd Generation Partnership Project Long Term Evolution (3GPP LTE).

The radio access network has a fixed structure according to a type of a mobile communication system. However, various forms of communication networks are expected to be integrated into an Internet Protocol (IP) based network in a next generation broadband mobile communication system. In addition, to address a problem of transmission delay between nodes constituting the radio access network, a radio access network having a 1-tier structure is being considered. A radio access network having a fixed structure in the existing various communication systems may present a problem when the systems operate over a network having a structure in which several networks are integrated into an IP based network. In other words, in an environment where various types of radio access networks having different fixed tier structures co-exist, a next generation broadband mobile communication system may experience significant limitation. This is because a compatibility with an existing system and inter-operability between heterogeneous networks are important functions in the next generation broadband mobile communication system.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for operating a radio access network having a structure that combines various tier structures in a broadband mobile communication system.

Another aspect of the present invention is to provide an apparatus and method for providing a service to a Mobile Station (MS) through a radio access network having a tier structure that is differentiated according to functions in a broadband mobile communication system.

According to an aspect of the present invention, a 1-tier node apparatus in a broadband mobile communication system is provided. The apparatus includes a first communicator for exchanging a plurality of pieces of control information for establishing a call of an MS with a higher-tier node, and a controller for allowing data of the MS to be transmitted and received through a radio access network having a 1-tier structure according to call establishment information received from the higher-tier node.

According to another aspect of the present invention, a broadband mobile communication system is provided. The system includes a 2-tier node for controlling a process of network access of an MS and a process of call establishment, and a 1-tier node for allowing data of the MS to be transmitted and received through a radio access network having a 1-tier structure according to call establishment information received from the 2-tier node.

According to another aspect of the present invention, a method of operating a 1-tier node in a broadband mobile communication system is provided. The method includes exchanging a plurality of pieces of control information for establishing a call of an MS with a higher-tier node, and allowing data of the MS to be transmitted and received through a radio access network having a 1-tier structure according to call establishment information received from the higher-tier node.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a schematic view illustrating a radio access network in a broadband mobile communication system according to an exemplary embodiment of the present invention;

FIG. 2 is a block diagram illustrating a 1-tier node in a broadband mobile communication system according to an exemplary embodiment of the present invention;

FIG. 3 is a block diagram illustrating a 2-tier node in a broadband mobile communication system according to an exemplary embodiment of the present invention;

FIG. 4 is a flowchart illustrating an operation of processing call establishment of a 1-tier node in a broadband mobile communication system according to an exemplary embodiment of the present invention; and

FIG. 5 is a flowchart illustrating an operation of processing call establishment of a 2-tier node in a broadband mobile communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A technique for operating a radio access network having a complex structure in a broadband mobile communication system of the present invention will be described hereinafter. Although an Orthogonal Frequency Division Multiplexing (OFDM) based mobile communication system will be described as an example, the present invention may also be applied to other types of mobile communication systems.

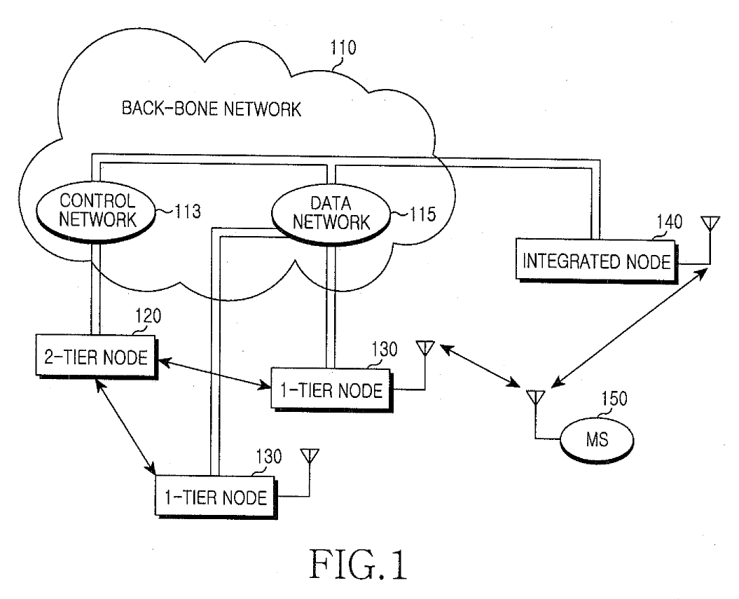

FIG. 1 is a schematic view illustrating a radio access network in a broadband mobile communication system according to an exemplary embodiment of the present invention.

Referring to FIG. 1, the radio access network includes a back-bone network 110. A 2-tier node 120, a plurality of 1-tier nodes 130 and an integrated node 140 are connected to the back-bone network 110. A Mobile Station (MS) 150 wirelessly communicates with one of the 1-tier nodes 130 and the integrated node 140. The 2-tier node 120 serves as a higher-tier node with respect to the plurality of 1-tier nodes 130.

The back-bone network 110 provides core functions for operating the broadband mobile communication system. Logically, the back-bone network 110 includes a control network 113 and a data network 115. The control network 113 is provided to control the MS 150 which attempts to access to the network. The data network 115 is provided to control user data of the MS 150.

The 2-tier node 120 is connected to the control network 113 of the back-bone network 110 and performs a necessary function to control the MS 150. That is, the 2-tier node 120 performs various functions such as user authentication, user location information management, capacity negotiation for the MS 150, and call processing. The 2-tier node 120 does not have a wireless communication function and thus the 2-tier node 120 communicates with the MS 150 through the 1-tier node 130. In an exemplary implementation, the 2-tier node 120 may include an Access Control Router (ACR), an Access Service Network_GateWay (ASN_GW), and an Access Core GateWay (ACGW).

The 1-tier node 130 which communicates with the MS 150 is connected to the data network 115 of the back-bone network 110 and performs a function related to user data communication of the MS 150. That is, the 1-tier node 130 performs a function for facilitating data communication, such as, Internet Protocol (IP) address allocation, Connection IDentifier (CID) allocation, error control, and encryption. In an exemplary implementation, the 1-tier node 130 may include a Radio Access Station (RAS), a Base Station (BS) and an Enhanced Node B (ENB). When the back-bone network 110 is an IP-based network, an IP router is provided so that the 1-tier node 130 is directly connected to the back-bone network 110.

The integrated node 140 is a node which combines both the 2-tier node 120 and the 1-tier node 130. The integrated node 140 is connected to the control network 113 and the data network 115 and thus performs functions of both the 2-tier node 120 and the 1-tier node 130. That is, the integrated node 140 is used when the control of the MS and the communication of the user data need to be processed through one node.

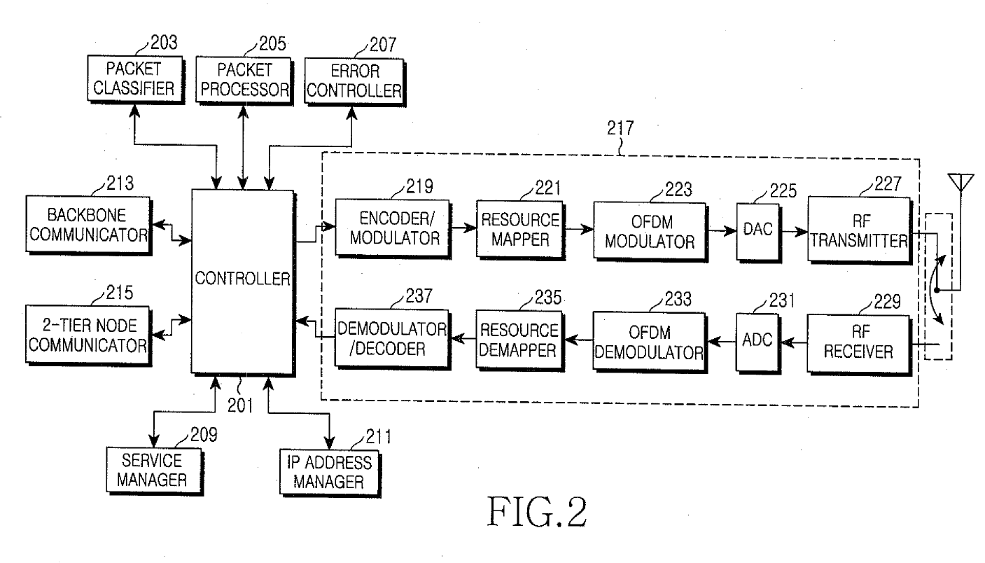

FIG. 2 is a block diagram illustrating a 1-tier node in a broadband mobile communication system according to an exemplary embodiment of the present invention.

Referring to FIG. 2, the 1-tier node includes a controller 201, a packet classifier 203, a packet processor 205, an error controller 207, a service manager 209, an IP address manager 211, a backbone communicator 213, a 2-tier node communicator 215 and a Radio Frequency (RF) communicator 217.

The controller 201 provides overall control to the 1-tier node. More specifically, the controller 201 controls network access of an MS and data communication through a wireless channel. The network access of the MS is achieved by performing Downlink (DL) and Uplink (UL) channel synchronization and ranging when the MS attempts to access to the network. The data communication through the wireless channel is achieved by controlling power or scheduling wireless resources. More particularly, according to an exemplary implementation of the present invention, the controller 201 controls the MS so that data is transmitted and received through a radio access network having a 1-tier structure and control information is transmitted and received through a radio access network having a 2-tier structure.

The packet classifier 203 determines whether a packet received from the MS is a data packet or a control information packet. If the data packet is received, the packet is transmitted to the back-bone network, and if the control information packet is received, the packet is transmitted to the 2-tier node. The control information packet transmitted to the 2-tier node includes a plurality of pieces of control information other than control information used for the purpose of wireless control (e.g., power control, channel quality, and so forth). The control information packet used for the purpose of wireless control is processed by the 1-tier node.

The packet processor 205 processes a data packet to facilitate communication with the MS. For example, the packet processor 205 compresses a header of the data packet and encrypts the data packet. The error controller 207 performs error control so that the MS can reliably transmit and receive data. For example, an Automatic Repeat reQuest (ARQ) function may be performed.

According to service capacity information of the MS and Quality of Service (QoS) request information, the service manager 209 determines a service policy for the MS and allocates a CID. For example, when the MS requests a broadcast service, the service manager 209 allocates a CID for the broadcast service. The service capacity information and the QoS request information are provided from the 2-tier node. The IP address manager 211 allocates an IP address for data communication to the MS when a call of the MS is established. Further, the IP address manager 211 maintains and manages the IP address.

The backbone communicator 213 communicates with the back-bone network under the control of the controller 201. For example, if the back-bone network is an IP-based network, the backbone communicator 213 has an IP routing function. The 2-tier node communicator 215 communicates with the 2-tier node under the control of the controller 201.

The RF communicator 217 includes an encoder/modulator 219, a resource mapper 221, an OFDM modulator 223, a Digital to Analog Converter (DAC) 225, an RF transmitter 227, an RF receiver 229, an Analog to Digital Converter (ADC) 231, an OFDM demodulator 233, a resource demapper 235 and a demodulator/decoder 237.

The encoder/modulator 219 encodes and modulates data to be transmitted to the MS. The resource mapper 221 maps the data provided from the encoder/modulator 219 to a sub-carrier resource. The OFDM modulator 223 converts a frequency domain signal, which is mapped to a frequency domain resource and is provided from the resource mapper 221, into a time domain signal by performing an Inverse Fast Fourier Transform (IFFT) operation. The DAC 225 converts a digital signal provided from the OFDM modulator 223 into an analog signal. The RF transmitter 227 converts a baseband signal provided from the DAC 225 into an RF signal and transmits the RF signal through an antenna.

The RF receiver 229 converts an RF signal received through the antenna into a baseband signal. The ADC 231 converts an analog signal provided from the RF receiver 229 into a digital signal. The OFDM demodulator 233 converts a time domain signal provided from the ADC 231 into a frequency domain signal by performing a Fast Fourier Transform (FFT) operation. The resource demapper 235 extracts data corresponding to an allocated resource from data which is mapped to a frequency domain and is provided from the OFDM demodulator 233. The demodulator/decoder 237 demodulates and decodes data provided from the resource demapper 235.

In the aforementioned structure, the controller 201 may perform functions of the packet classifier 203, the packet processor 205, the error controller 207, the service manager 209 and the IP address manager 211. Although these components are depicted by separate blocks in FIG. 2, this is for explanation purpose only. Thus, when the 1-tier node is implemented in practice, these functions may be entirely or partially performed by the controller 201.

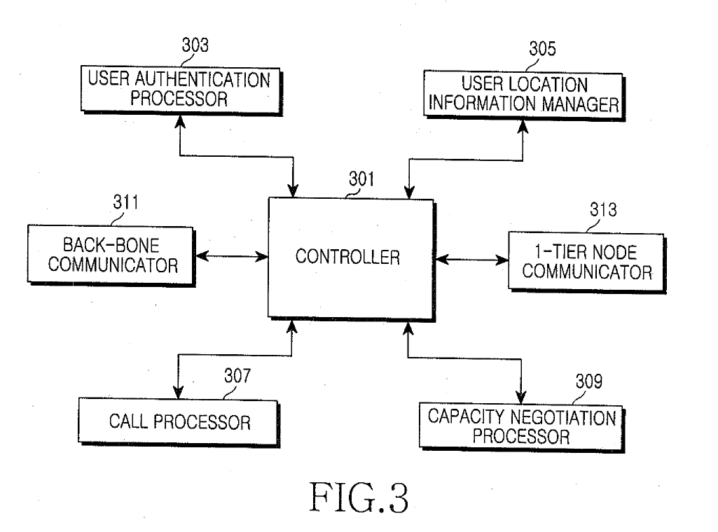

FIG. 3 is a block diagram illustrating a 2-tier node in a broadband mobile communication system according to an exemplary embodiment of the present invention.

Referring to FIG. 3, the 2-tier node includes a controller 301, a user authentication processor 303, a user location information manager 305, a call processor 307, a capacity negotiation processor 309, a back-bone communicator 311 and a 1-tier node communicator 313.

The controller 301 provides overall control to the 2-tier node. More particularly, according to an exemplary implementation of the present invention, the controller 301 controls a function for processing control information of an MS.

The user authentication processor 303 evaluates user information when the MS attempts to access to the network and determines whether a user is authorized to use a service. The user location information manager 305 maintains and manages location information of a plurality of MSs existing within a coverage area of the 2-tier node. The call processor 307 sends a call establishment request to an MS or receives the call establishment request from the MS. That is, when the call establishment request is sent to the MS, the call processor 307 recognizes a location of the MS and performs a paging function. In addition, when the call establishment request is received from the MS, the call processor 307 verifies the call generation and performs a function for service connection. The capacity negotiation processor 309 evaluates service capacity information of the MS and QoS request information when a call of the MS is established. That is, the capacity negotiation processor 309 evaluates capacity (e.g., a type of an available service that can be supported by the MS, the number of antennas, and so forth) and a service level of the MS wherein the service level is determined by a contract of a service provider.

The back-bone communicator 311 communicates with the back-bone network under the control of the controller 301. For example, when the back-bone network is an IP-based network, the back-bone communicator 311 may be an IP router. The 1-tier node communicator 313 communicates with the 1-tier node under the control of the controller 301.

In the aforementioned structure, the controller 301 may perform functions of the user authentication processor 303, the user location information manager 305, the call processor 307 and the capacity negotiation processor 309. Although these components are depicted by separate blocks in FIG. 3, this is for explanation purpose only. Thus, in practice, these functions may be entirely or partially performed by the controller 301.

As described above, the 1-tier node and the 2-tier node co-exist in the broadband mobile communication system. The 1-tier node and the 2-tier node are independent from each other and perform their own functions. In an exemplary implementation of the present invention, the broadband mobile communication system may include an integrated node in which both the 1-tier node and the 2-tier node are combined. Although control information is processed in a different manner from data in the 1-tier node and the 2-tier node, since the integrated node combines the 1-tier node and the 2-tier node, the mobile communication system of the present invention can operate a radio access network in a more flexible manner.

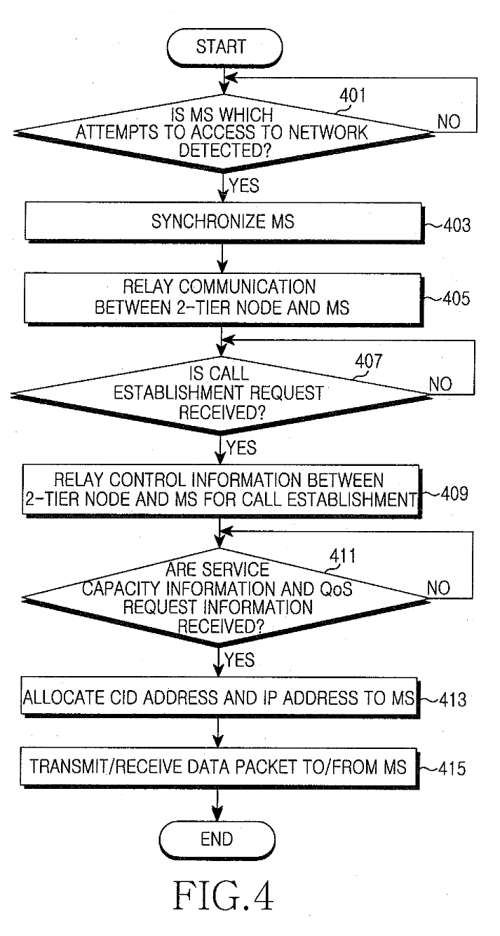

FIG. 4 is a flowchart illustrating an operation of processing call establishment of a 1-tier node in a broadband mobile communication system according to an exemplary embodiment of the present invention.

Referring to FIG. 4, in step 401, the 1-tier node determines whether there is an MS which attempts to access to the network. That is, the 1-tier node determines whether there is an MS whose power is ON in a cell area of the 1-tier node.

Upon detecting the MS which attempts to access to the network, in step 403, the 1-tier node performs UL and DL synchronization on the MS.

In step 405, the 1-tier node relays communication of control information between a 2-tier node and the MS so that the MS can access the network. That is, all control functions of the MS are performed by the 2-tier node.

In step 407, the 1-tier node determines whether a call establishment request is received from the MS.

Upon receiving the call establishment request, in step 409, the 1-tier node relays control information between the 2-tier node and the MS so that a call of the MS is established. That is, the 1-tier node reports to the 2-tier node the fact that the call establishment request is generated, and relays the control information for the call establishment.

In step 411, the 1-tier node determines whether service capacity information of the MS and QoS request information are received from the 2-tier node.

Upon receiving the service capacity information and the QoS request information, in step 413, the 1-tier node allocates a CID and an IP address to the MS by using the received information.

After allocating the CID and the IP addresses, in step 415 the 1-tier node is directly connected to a back-bone network (e.g., the Internet) and thus a data packet is transmitted to and received from the MS. Specifically, the 1-tier node performs IP routing so that a UL data packet received from the MS is transmitted to the back-bone network and a DL data packet received from the back-bone network is transmitted to the MS.

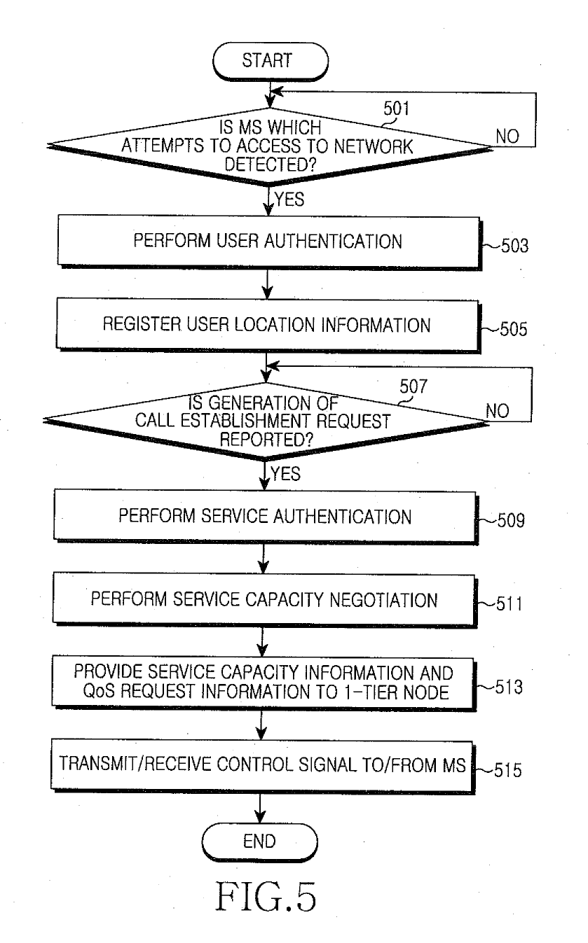

FIG. 5 is a flowchart illustrating an operation of processing call establishment of a 2-tier node in a broadband mobile communication system according to an exemplary embodiment of the present invention.

Referring to FIG. 5, in step 501, the 2-tier node determines whether there is an MS which attempts to access to the network. Since the 2-tier node does not directly communicate with the MS, the 2-tier node detects the MS which attempts to access to the network by using information received from a 1-tier node.

Upon detecting the MS which attempts to access to the network, in step 503, the 2-tier node performs user authentication. To determine whether the MS can access the network, the 2-tier node communicates with a server for managing user authentication through a back-bone network (e.g., the Internet).

In step 505, the 2-tier node determines and registers user location information. In this step, it is determined in which cell the MS is located, and the location of the MS is continuously traced.

In step 507, the 2-tier node determines whether the 1-tier node reports the generation of a call establishment requested by the MS.

In step 509, the 2-tier node performs a service authentication process. By communicating with a server for managing service authentication through the back-bone network, the 2-tier node determines whether the MS is authorized to receive a service.

In step 511, the 2-tier node negotiates a service capacity of the MS. That is, the 2-tier node evaluates service capacity information, for example, a type of service that can be supported by the MS, the number of antennas, and so on. Further, the 2-tier node evaluates QoS request information of the MS.

Upon evaluating the service capacity information and the QoS request information, in step 513, the 2-tier node provides the service capacity information and the QoS request information to the 1-tier node. The reason why the service capacity information and the QoS request information are transmitted to the 1-tier node is that these pieces of information are necessary for data communication through a wireless channel.

In step 515, the 2-tier node transmits and receives control information to and from the MS via the 1-tier node.

In exemplary embodiments of the present invention described with reference to FIGS. 3 and 4, operations of the 1-tier node and the 2-tier node have been described in the broadband mobile communication system. The 1-tier node and the 2-tier node are independent from each other and perform their own functions. According to another exemplary embodiment, one node may perform functions of both the 1-tier node and the 2-tier node, and such a node is referred to as an integrated node. Although control information is processed in a different manner from data in the 1-tier node and the 2-tier node, since the integrated node combines the 1-tier node and the 2-tier node, the mobile communication system according to an exemplary embodiment of the present invention may operate a radio access network in a further flexible manner.

According to exemplary embodiments of the present invention, in a broadband mobile communication system, a radio access network having a 1-tier structure and a radio access network having a 2-tier structure co-exist so that services are provided through either one of the radio access networks according to information types. Therefore, advantages of the both radio access networks can be obtained. Optionally, functions of the both radio access networks can be provided using the radio access network having the 1-tier structure. Therefore, flexibility of network operation can increase.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A flexible radio access network (RAN) in a broadband mobile communication system, the apparatus comprising:
a 1 tier node for transmitting traffic data to a Mobile Station (MS); and;
a 2 tier node for handling a control information for a call set-up to communicate with Mobile Station or for the MS location to register on the system; and
a controller for determining whether a data received from the MS is the control information or not, and then classifying the control information and the traffic information of the MS.

2. The apparatus of claim 1, wherein the 1 tier node and the 2 tier node are located at the RAN.

3. The apparatus of claim 1, wherein the 1 tier node and the 2 tier node are located at each of the RAN.

4. The apparatus of claim 1, wherein the 1 tier node performs a function for facilitating data communication, such as, Internet Protocol (IP) address allocation, Connection IDentifier (CID) allocation, error control, and encryption

5. The apparatus of claim 1, wherein the 2-tier node performs a functions among of user authentication, user location information management, capacity negotiation for the MS.

6. The apparatus of claim 1, wherein the 2-tier node includes an Access Control Router (ACR), an Access Service Network_GateWay (ASN_GW), and an Access Core GateWay (ACGW)

7. The apparatus of claim 1, wherein the 1-tier node includes a Radio Access Station (RAS), a Base Station (BS) and an Enhanced Node B (ENB)

8. A 1-tier node apparatus in a broadband mobile communication system, the apparatus comprising:
a first communicator for exchanging a plurality of pieces of control information for establishing a call of a Mobile Station (MS) with a higher-tier node; and
a controller for allowing data of the MS to be transmitted and received through a radio access network having a 1-tier structure according to call establishment information received from the higher-tier node

9. The apparatus of claim 8, wherein the controller performs synchronization on the MS when an attempt is made to access to a network through a wireless channel.

10. The apparatus of claim 8, wherein the call establishment information comprises at least one of service quality information of the MS and Quality of Service (QoS) request information.

11. The apparatus of claim 8, further comprising:
a service manager for allocating a Connection IDentifier (CID) to the MS according to the call establishment information; and
an Internet Protocol (IP) manager for allocating an IP address to the MS under the control of the controller.

12. The apparatus of claim 8, further comprising a second communicator for communicating directly with a back-bone network so that data communication of the MS can be achieved through the radio access network having a 1-tier structure.

13. The apparatus of claim 8, further comprising:
a packet processor for compressing a header of a data packet exchanged with the MS and for encrypting the data packet; and
an error controller for performing Automatic Repeat reQuest (ARQ) while communicating with the MS.

14. A broadband mobile communication system, comprising:
a 2-tier node for controlling a process of network access of a Mobile Station (MS) and for controlling a process of call establishment; and
a 1-tier node for allowing data of the MS to be transmitted and received through a radio access network having a 1-tier structure according to call establishment information received from the 2-tier node.

15. The system of claim 14, wherein the call establishment information comprises at least one of service quality information of the MS and Quality of Service (QoS) request information.

16. The system of claim 14, wherein the 1-tier node allocates a Connection IDentifier (CID) and an Internet Protocol (IP) to the MS according to the call establishment information.

17. The system of claim 14, wherein the 1-tier node directly communicates with a back-bone network so that data communication of the MS can be achieved through the radio access network having a 1-tier structure.

18. The system of claim 17, wherein the 1-tier node comprises an Internet Protocol (IP) routing function.

19. The system of claim 14, wherein the 1-tier node performs at least one process selected from a group consisting of compressing a header of a data packet exchanged with the MS, encrypting the data packet, and performing Automatic Repeat reQuest (ARQ).

20. The system of claim 14, wherein the 2-tier node performs at least one process selected from a group consisting of authenticating a user of the MS, registering user location information, negotiating service capacity, and authenticating a service.

21. The system of claim 14, further comprising an integrated node for controlling a process of network access of the MS and a call establishment process and for allowing data of the MS to be transmitted and received through the radio access network having a 1-tier structure.

22. A method of operating a 1-tier node in a broadband mobile communication system, the method comprising:
exchanging a plurality of pieces of control information for establishing a call of a Mobile Station (MS) with a higher-tier node; and
allowing data of the MS to be transmitted and received through a radio access network having a 1-tier structure according to call establishment information received from the higher-tier node.

23. The method of claim 22, further comprising performing synchronization on the MS which attempts to access to a network through a wireless channel.

24. The method of claim 22, wherein the call establishment information comprises at least one of service quality information of the MS and Quality of Service (QoS) request information.

25. The method of claim 22, further comprising:
allocating a Connection IDentifier (CID) to the MS according to the call establishment information; and
allocating an Internet Protocol (IP) address to the MS.
